(19) United States
(12) Patent Application Publication
(10) Pub. No.: US 2005/0024718 A1
(43) Pub. Date: Feb. 3, 2005

(54) Microscope control apparatus, microscope apparatus and objective lens for microscope

(75) Inventors: Ichiro Sase, Yokohama-shi (JP); Katsuya Watanabe, Yokohama-shi (JP)

Correspondence Address: MORGAN LEWIS & BOCKIUS LLP, 1111 PENNSYLVANIA AVENUE NW, WASHINGTON, DC, 20004, US

(73) Assignee: NIKON CORPORATION

(21) Appl. No.: 10/899,025

(22) Filed: Jul. 27, 2004

(30) Foreign Application Priority Data
Jul. 28, 2003 (JP) 2003-202503

(51) Int. Cl. G02B 21/00

(52) U.S. Cl. 359/368; 359/383

(57) ABSTRACT

A microscope control apparatus is used with a microscope apparatus attached with a microscope objective lens having an aberration correction lens. The microscope control apparatus includes a memory in which information on driving amounts of the aberration correction lens that are optimum for various observation conditions respectively, entry device for allowing an observer to enter a single parameter or multiple parameters for specifying an observation condition set upon observation, and calculation device for determining a driving amount of the aberration correction lens that is optimum for the observation condition specified by the parameter(s) based on the information.

This application claims the benefit of Japanese Patent application No. 2003-202503 which is hereby incorporated by reference.

### BACKGROUND OF THE INVENTION

1. Field of the Invention

The present invention relates to a microscope control apparatus, a microscope apparatus and an objective lens of a microscope.

2. Related Background Art

Some kinds of objective lenses of a microscope is provided with an aberration correction lens that can move in the optical axis direction (see, for example, Japanese Patent Application Laid-Open No. 2002-169101).

With a change in the thickness and refractive index of a cover glass for protecting the surface of a specimen upon, for example, replacement of the cover glass, the state of aberrations changes. In such a case, a new position (i.e. an optimum position) of an aberration correction lens at which the aberrations are made minimum (in other words, at which an image of the specimen can be clearly observed) is determined and the aberration correction lens is moved to that optimum position.

However, changes in the state of aberrations can also occur occasions other than mentioned above. For example, when a three-dimensional image of an specimen is to be obtained, the distance (or depth) of the plane to be observed in the same single specimen from the surface thereof is changed. In this process, the thickness of the air and the thickness of the specimen existing between the plane to be observed and the objective lens of the microscope change, and therefore it is considered that the state of aberrations will change.

Furthermore, when the observation temperature of an specimen changes upon obtaining an image of a certain observation target plane in the specimen, it is considered that the state of aberrations will change since the refractive index of materials changes with a change in the temperature.

Therefore, when a change in observation conditions in the optical path of the microscope objective lens occurs, it is considered necessary to move the aberration correction lens to an optimum position.

However, if a complex operation of determining the optimum position of the aberration correction lens is to be performed every time a change in the observation condition occurs, the efficiency of observation will be deteriorated significantly.

### SUMMARY OF THE INVENTION

In view of the above situation, an object of the present invention is to provide a microscope control apparatus that enables expeditious aberration correction in accordance with a change in observation conditions.

It is a further object of the present invention to provide a microscope apparatus in which aberration correction can be performed expeditiously in accordance with a change in observation conditions.

It is yet another object of the present invention to provide a microscope objective lens that is suitable for use in that microscope apparatus.

According to a first aspect of the present invention, there is provided a microscope control apparatus for a microscope apparatus attached with a microscope objective lens having an aberration correction lens, comprising a memory means in which information on driving amounts of the aberration correction lens that are optimum for various observation conditions respectively, entry means for allowing an observer to enter a single parameter or multiple parameters for specifying an observation condition set upon observation, and calculation means for determining a driving amount of the aberration correction lens that is optimum for the observation condition specified by the parameter(s) based on the information.

According to a second aspect of the present invention, the aforementioned parameter(s) used in the microscope control apparatus according to the first aspect of the invention includes at least one of the following parameters: a parameter indicative of a refractive index of an object to be observed; a parameter indicative of a temperature of the object to be observed; a parameter indicative of a position of an observation target plane in the object to be observed; a parameter indicative of a refractive index of a medium present between the observation target plane and the microscope objective lens; and a parameter indicative of a thickness of the medium present between the observation target plane and the microscope objective lens.

According to a third aspect of the present invention, there is provided a microscope apparatus comprising a microscope objective lens having an aberration correction lens, a memory means in which information on driving amounts of the aberration correction lens that are optimum for various observation conditions respectively, entry means for allowing an observer to enter a single parameter or multiple parameters for specifying an observation condition set upon observation, calculation means for determining a driving amount of the aberration correction lens that is optimum for the observation condition specified by the parameter(s) based on the information, and driving means for driving the aberration correction lens by the determined driving amount.

According to a fourth aspect of the present invention, there is provided a microscope objective lens having an aberration correction lens, wherein the aberration correction lens can be moved along an optical axis direction in accordance with an electric signal that is supplied externally.

According to the present invention as described above, a microscope control apparatus that enables expeditious aberration correction in accordance with a change in the observation condition can is realized.

Furthermore, according to the present invention, a microscope apparatus in which aberrations can be corrected expeditiously in accordance with a change in the observation condition is realized.

Still further, according to the present invention, a microscope objective lens that is suitable for use in that microscope apparatus is realized.

### BRIEF DESCRIPTION OF THE DRAWINGS

FIG. 1 shows the structure of a microscope system according to the first embodiment.

FIGS. 2A, 2B and 2C illustrate an operation process of the microscope system according to the first embodiment.

FIGS. 3A and 3B show a correspondence table stored in a memory 24.

FIGS. 4A and 4B show simulated data of the optimum position in the optical axis direction of an aberration correction lens 11B in relation to the observation condition concerning temperature T and refractive index n.

FIG. 5 shows point spread functions (PFS) (simulated data) of the microscope objective lens 11 in the case that no aberration correction depending on the depth Z is performed.

FIG. 6 shows point spread functions (PFS) (simulated data) of the microscope objective lens 11 in the case that optimum aberration correction depending on the depth Z is performed.

FIG. 7 shows the structure of a microscope system used with a measurement method according to the second embodiment.

FIG. 8 is a diagram showing an automatic operation process of a microscope system.

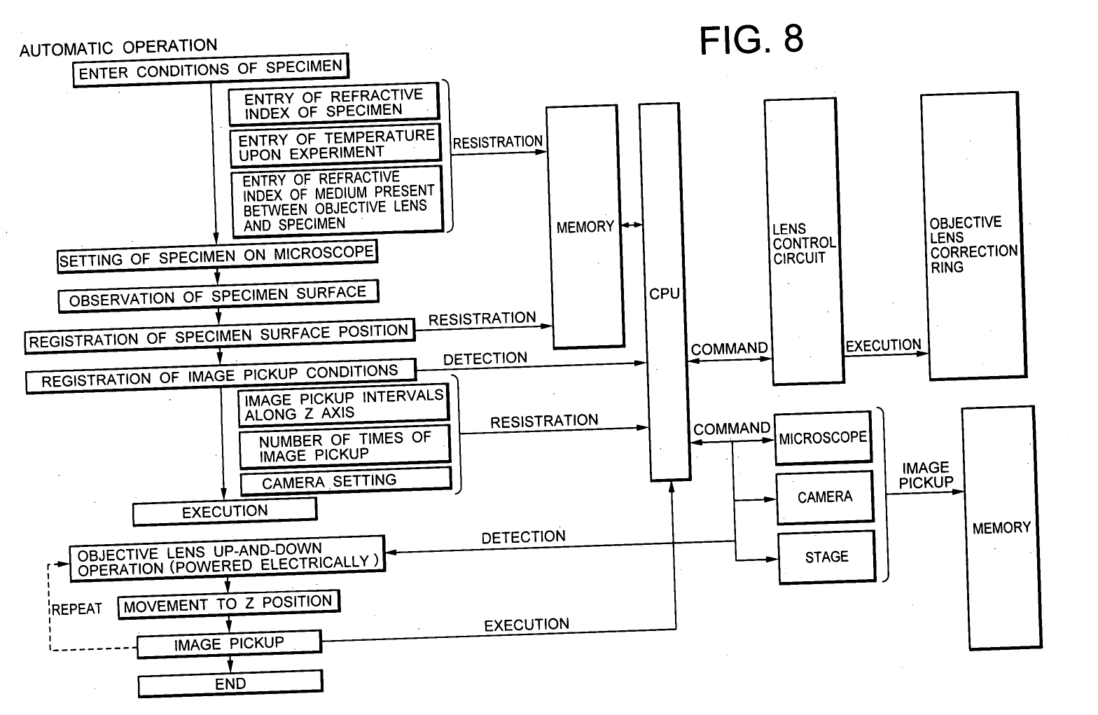

FIG. 9 is a diagram showing a manual operation process of a microscope system.

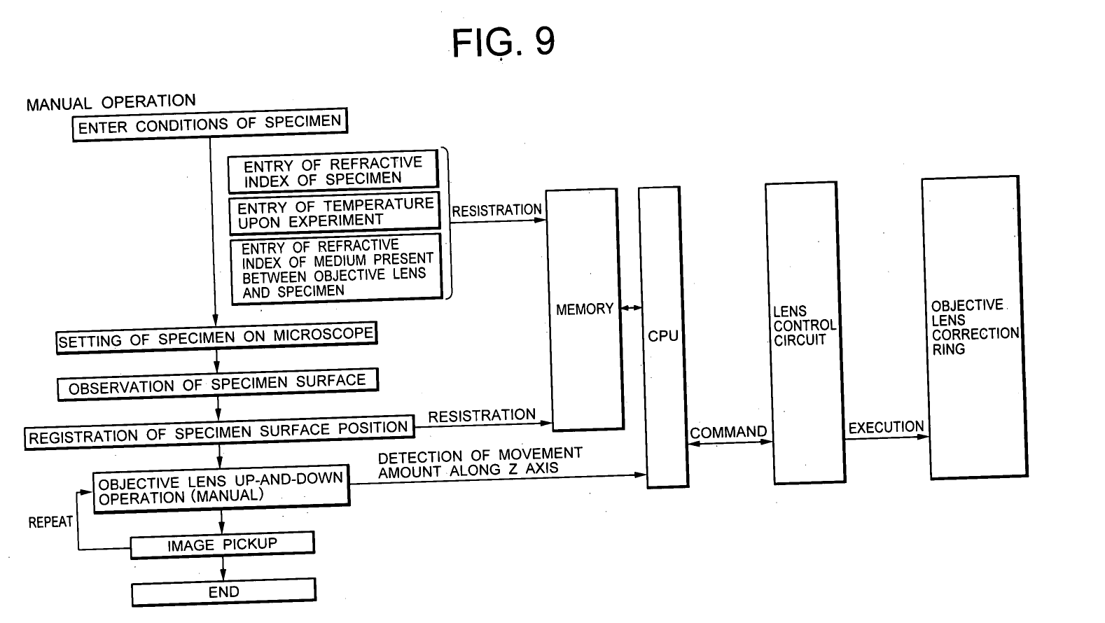

### DETAILED DESCRIPTION OF THE PREFERRED EMBODIMENTS

In the following, embodiments of the present invention will be described in detail with reference to the accompanying drawings.

[First Embodiment]

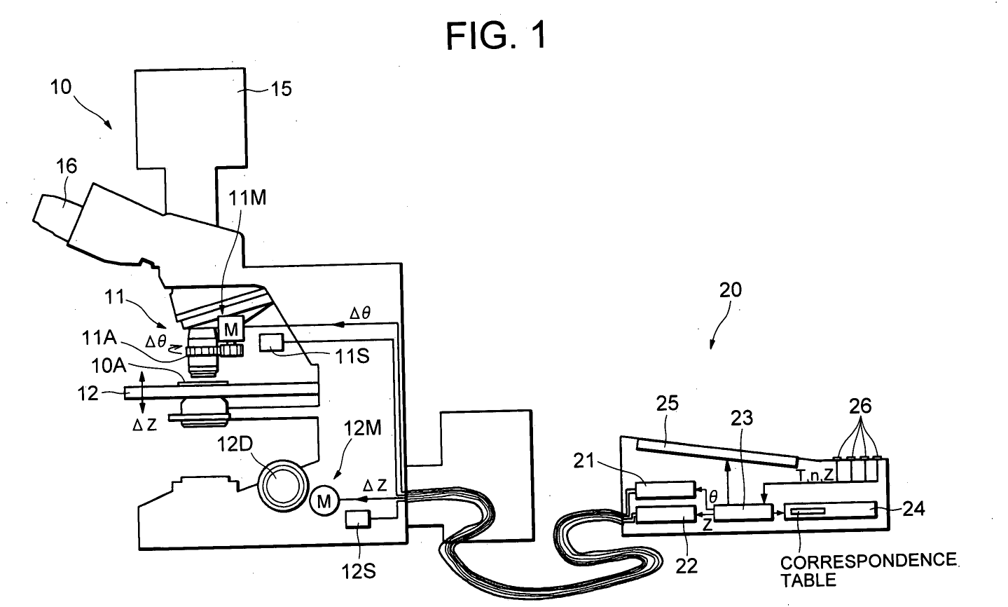

A first embodiment of the present invention will be described with reference to FIGS. 1, 2, 3, 4, 5 and 6.

This embodiment is directed to a microscope system in which the present invention is applied. Here, a description will be made with reference to a case in which a three-dimensional image of an object to be observed (i.e. a specimen 10A) is obtained.

Referring to FIG. 1, the microscope system of this embodiment includes a microscope apparatus 10 and a controller 20 connected with the microscope apparatus 10 via a cable or the like. In the following, the microscope apparatus 10 and the controller 20 will be described in the mentioned order.

The microscope apparatus 10 is provided with a microscope objective lens 11, a stage 12, a camera 15, an eyepiece lens 16, a focus adjustment apparatus and an illumination apparatus.

The stage 12 is driven by an electromotive stage driving mechanism 12M composed of a force transmission mechanism (including gears and belt etc.) and a motor. The stage driving mechanism 12M is adapted to move the stage 12 in accordance with a driving signal (ΔZ) supplied from the controller 20.

The position of the stage 12 set by the stage driving mechanism 12M is detected by a sensor 12S. A detection signal output from the sensor 12S is sent to the controller 20.

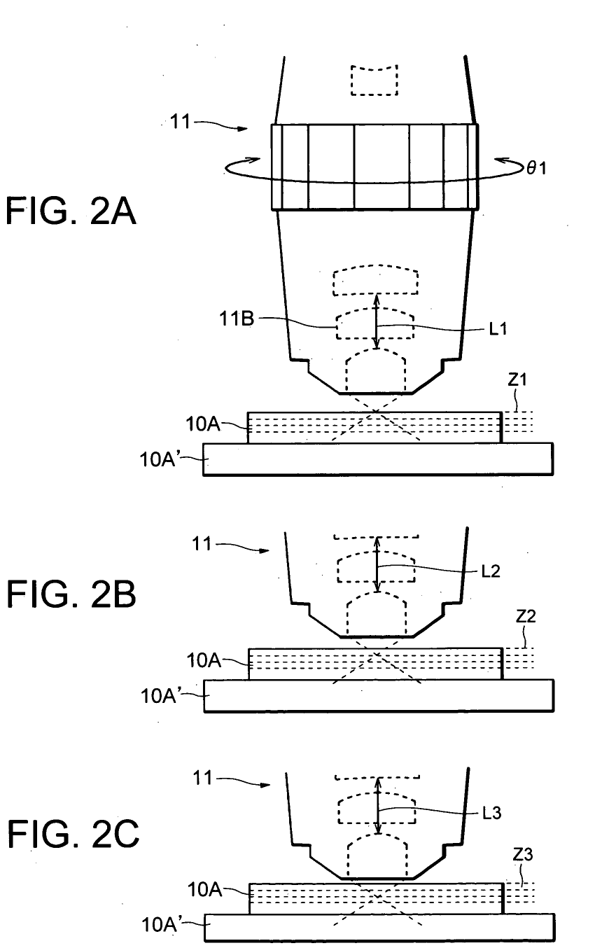

A specimen 10A placed on the stage 12 is held by a transparent glass plate 10A′ as shown in FIGS. 2A to 2C in an enlarged manner.

The microscope apparatus 10 is of a transmissive, bright field observation type, and therefore the specimen 10A is illuminated from the glass plate 10A′ side so that a light flux transmitted through the specimen 10A is incident on the microscope objective lens 11.

The light flux incident on the microscope objective lens 11 is focused by the lenses in the microscope objective lens 11 and other optical systems that are not shown in the drawings. Thus, an image of the specimen 10A is formed and observed by an observer through the eyepiece lens 16 or a monitor (not shown) connected to the camera 15.

The microscope objective lens 11 has an aberration correction lens 11B provided in the interior thereof.

The aberration correction lens 11B is movable in the optical axis direction. The aberration correction lens 11B is moved interlocked with rotation of a correction ring 11A provided on the outer periphery of the microscope objective lens 11.

With the movement of the aberration correction lens 11B, the state of aberrations generated in the optical system existing between the object plane and the image plane of the microscope objective lens 11 (which will be simply referred to as the aberrations, hereinafter) will change.

The correction ring 11A is driven by an electromotive lens driving mechanism 11M composed of a force transmission mechanism (including gears and belt etc.) and a motor. The lens driving mechanism 11M drives the correction ring 11A in accordance with a driving signal (Δθ) sent from the controller 20.

The rotational position of the correction ring 11A set by the lens driving mechanism 11M is detected by a sensor 11S.

A detection signal output from the sensor 11S is sent to the controller 20.

The controller 20 is provided with a display device 25, a switch 26, a CPU 23, a lens control circuit 21, a stage control circuit 22 and a memory 24.

The CPU 23 send various commands to the display device 25, the lens control circuit 21 and the stage control circuit 22 based on a signal entered through the switch 26 and a predetermined program.

The display device 25 displays appropriate information for the observer in accordance with commands supplied from the CPU 23.

When operated by the observer, the switch 26 provides a signal corresponding to the operation to the CPU 23.

The display device 25 and the switch 26 in this embodiment serve as a user interface which allows the observer to enter parameters for specifying an observation condition set for the optical path of the microscope objective lens 11.

Here, it is assumed that the temperature T of the specimen 10A, the refractive index n of the specimen 10A and the depth (i.e. the distance from the surface of the specimen) Z of the observation target plane (or the plane to be observed) in the specimen 10A are changed, and the values of the temperature T, the refractive index n and the depths Z1, Z2, . . . of the observation target plane are used as the parameters.

For that purpose, the display device 25 can display an entry screen for prompting the observer to enter values of the temperature T, the refractive index n and the depths Z1, Z2, . . . . While the entry screen is displayed, the observer can enter values designating the temperature T, the refractive index n and the depths Z1, Z2, . . . through the switch 26.

The lens control circuit 21 is connected with the lens driving mechanism 11M and the sensor 11S in the microscope apparatus 10.

The lens control circuit 21 generates a driving signal (Δθ) required for rotating the correction ring 11A to its target rotational position based on a detection signal indicative of the current rotational position of the correction ring 11A supplied from the sensor 11S and supplies that driving signal (Δθ) to the lens driving mechanism 11M

The stage control circuit 22 is connected with the stage driving mechanism 12M and the sensor 12S in the microscope apparatus 10.

The stage control circuit 22 generates a driving signal (ΔZ) required for moving the stage 12 to its target position based on the target position of the stage designated by the CPU 23 and a detection signal supplied from the sensor 12S and supplies that driving signal (ΔZ) to the stage driving mechanism 12M.

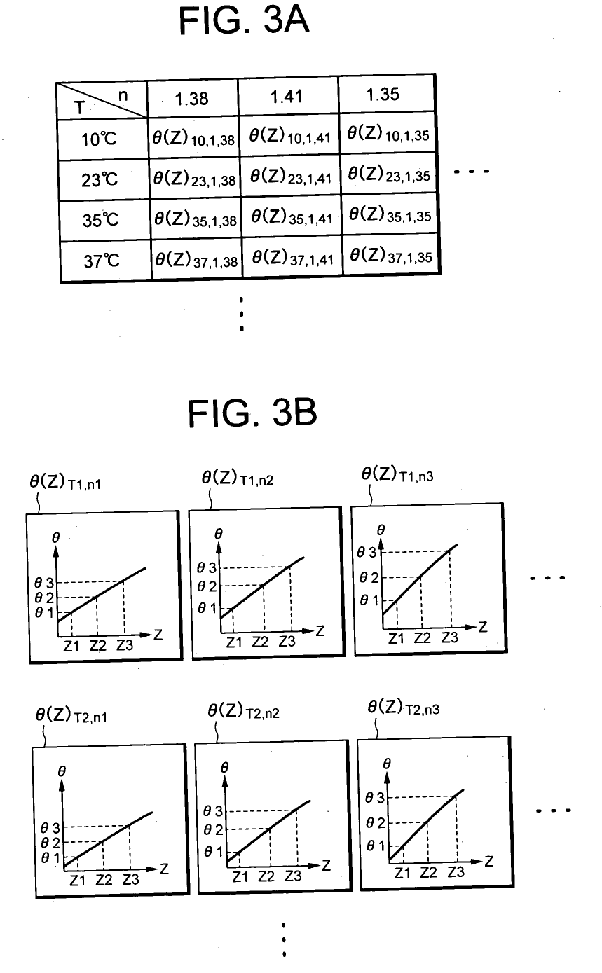

In the memory 24, information required for the operation of CPU 23 is stored in advance. Especially, a correspondence table shown in FIG. 3A is stored in the memory 24 in this embodiment.

This correspondence table is used for associating various observation conditions as different combinations of the temperature T and the refractive index n with respective optimum rotational positions θ of the correction ring 11A. (Here, the optimum rotational position θ is defined as the rotation position at which the aberrations become minimum.)

The optimum rotational position θ varies depending on the depth Z of the observation target plane in the specimen 10A even under the same observation condition with the same combination of the temperature T and the refractive index n.

Consequently, the optimum rotational position θ is represented as a function of the depth Z (i.e. depth-angle curves θ(Z)_{T,n}) as shown in FIG. 3B.

The depth-angle curves θ(Z)_{T,n} are known functions and information concerning one depth-angle curve θ(Z)_{T,n} is consisting of two to five, more preferably two or three values that define that function.

The optimum rotational position θ (i.e. the optimum depth-angle curve θ(Z)_{T,n}) for each of various observation conditions can be determined by an experiment using the microscope objective lens 11 or a simulation using data of the microscope objective lens 11.

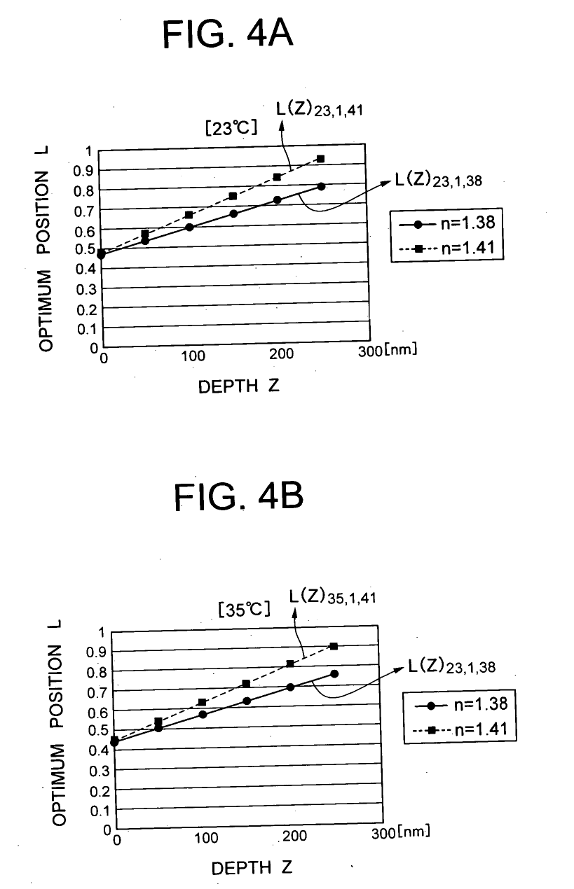

In connection with this, FIGS. 4A and 4B show simulated data of the optimum position L in the optical axis direction of the aberration correction lens 11B for observation conditions concerning the temperature T and the refractive index n. (Here, the optimum position L means the position at which aberrations become minimum.)

Since the optimum position L varies depending on the depth Z of the plane to be observed in the specimen 10A even under the same observation condition with the same combination of the temperature T and the refractive index n, the optimum position L is represented as a function of the depth Z (i.e. depth-position curves L(Z)_{T,n}).

In FIG. 4A, data for the observation condition of a temperature T of 23° C. and a refractive index n of 1.38 and data for the observation condition of a temperature T of 23° C. and a refractive index n of 1.41 are shown.

In FIG. 4B, data for the observation condition of a temperature T of 35° C. and a refractive index n of 1.38 and data for the observation condition of a temperature T of 35° C. and a refractive index n of 1.41 are shown.

There is a known one-to-one relationship between the optimum position L of the aberration correction lens 11B and the optimum rotational position θ for realizing that optimum position L.

Therefore, the depth-angle curve θ(Z)_{T,n} can be determined based on the depth-position curve L(Z)_{T,n} obtained by an experiment or a simulation and the above-mentioned known relationship.

The constitution of the microscope system of this embodiment has been described in the foregoing.

In the following, the operation of the microscope system according to the invention upon observation will be described.

A specimen 10A to be observed is placed on the stage 12.

An entry screen is displayed on the display device 25.

Prompted by the displayed screen, the observer operates the switch 26 to enter the values of the temperature T of the specimen 10A, the refractive index n of the specimen 10A and the depth Z1, Z2, Z3 of the observation target plane.

When the observation target plane of depth Z1 is to be observed, the CPU 23 calculates a target position in the Z direction (i.e. the optical axis direction) of the stage 12 with which the focal point of the microscope objective lens 11 coincides with the observation target plane of depth Z1 in the manner shown in FIG. 2A and supplies that target position to the stage control circuit 22.

Based on that target position of the stage 12 and a detection signal supplied from the sensor 12S, the stage control circuit 22 generates a driving signal (ΔZ) required for moving the stage 12 to the target position and supplies it to the stage driving mechanism 12M. Then, the stage driving mechanism 12M drives the stage 12 to move it to the target position.

On the other hand, the CPU 23 refers to the depth-angle curve θ(Z)_{T,n} (FIG. 3B) associated with the observation condition of the temperature T and the refractive index n entered by the observer picked up from the correspondence table (FIG. 3A) stored in the memory 24. The CPU 23 determines the optimum rotational position θ1 for depth Z1 based on that depth-angle curve θ(Z)_{T,n}.

The CPU 23 supplies that optimum rotational position θ1 to the lens control circuit 21 as the target rotational position.

Based on that target rotational position and a detection signal supplied from the sensor 11S, the lens control circuit 21 generates a signal (Δθ) required for rotating the correction ring 11A to the target rotational position and supplies that signal to the lens driving mechanism 11M. Then, the lens driving mechanism 11M drives the correction ring 11A to rotate it until it assumes the target rotational position. Interlocked with the rotation of the correction ring 11A, the aberration correction lens 11B is moved to the optimum position.

Thus, aberrations are reduced sufficiently and an image of the observation target plane of depth Z1 can be observed clearly through the eyepiece lens 16 or the monitor (not shown) connected with the camera 15.

When the observation target plane of depth Z2 is to be observed, the CPU 23 calculates a target position in the Z direction (i.e. the optical axis direction) of the stage 12 with which the focal point of the microscope objective lens 11 coincides with the observation target plane of depth Z2 in the manner shown in FIG. 2B and supplies that target position to the stage control circuit 22.

Based on that target position of the stage 12 and a detection signal coming from the sensor 12S, the stage control circuit 22 generates a driving signal (ΔZ) required for moving the stage 12 to the target position and supplies it to the stage driving mechanism 12M. Then, the stage driving mechanism 12M drives the stage 12 to move it to the target position.

On the other hand, the CPU 23 determines the optimum rotational position θ2 for depth Z2 based on the above-mentioned depth-angle curve θ(Z)_{T,n}.

The CPU 23 supplies that optimum rotational position θ2 to the lens control circuit 21 as the target rotational position.

Based on that target rotational position and a detection signal supplied from the sensor 11S, the lens control circuit 21 generates a signal (Δθ) required for rotating the correction ring 11A to the target rotational position and supplies it to the lens driving mechanism 11M. Then, the lens driving mechanism 11M drives the correction ring 11A to rotate it until it assumes the target rotational position. Interlocked with the rotation of the correction ring 11A, the aberration correction lens 11B is moved to the optimum position.

Thus, aberrations are reduced sufficiently and an image of the observation target plane of depth Z2 can be observed clearly through the eyepiece lens 16 or the monitor (not shown) connected with the camera 15.

When the observation target plane of depth Z3 is to be observed, the CPU 23 calculates a target position in the Z direction (i.e. the optical axis direction) of the stage 12 with which the focal point of the microscope objective lens 11 coincides with the observation target plane of depth Z3 in the manner shown in FIG. 2C and supplies that target position to the stage control circuit 22.

Based on that target position of the stage 12 and a detection signal supplied from the sensor 12S, the stage control circuit 22 generates a driving signal (ΔZ) required for moving the stage 12 to the target position and supplies it to the stage driving mechanism 12M. Then, the stage driving mechanism 12M drives the stage 12 to move it to the target position.

On the other hand, the CPU 23 determines the optimum rotational position θ3 for depth Z3 based on the above-mentioned depth-angle curve θ(Z)_{T,n}.

The CPU 23 supplies that optimum rotational position θ3 to the lens control circuit 21 as the target rotational position.

Based on that target rotational position and a detection signal coming from the sensor 11S, the lens control circuit 21 generates a signal (Δθ) required for rotating the correction ring 11A to the target rotational position and supplies it to the lens driving mechanism 11M. Then, the lens driving mechanism 11M drives the correction ring 11A to rotate it until it assumes the target rotational position. Interlocked with the rotation of the correction ring 11A, the aberration correction lens 11B is moved to the optimum position.

Thus, aberrations are reduced sufficiently and an image of the observation target plane of depth Z3 can be observed clearly through the eyepiece lens 16 or the monitor (not shown) connected with the camera 15.

As per the above, in the microscope system of this embodiment, when observation is performed, aberration correction is carried out automatically in accordance with a change in the observation condition without any complicated operation. Therefore, aberration correction is attained expeditiously.

In addition, since the temperature T, refractive index n and depth Z are used as the parameters, optimum aberration correction taking into account the temperature T, refractive index n and depth Z can be attained.

Further, continuous observations can be performed automatically by changing successively the observation conditions in accordance with the abovementioned parameters specifying the observation conditions.

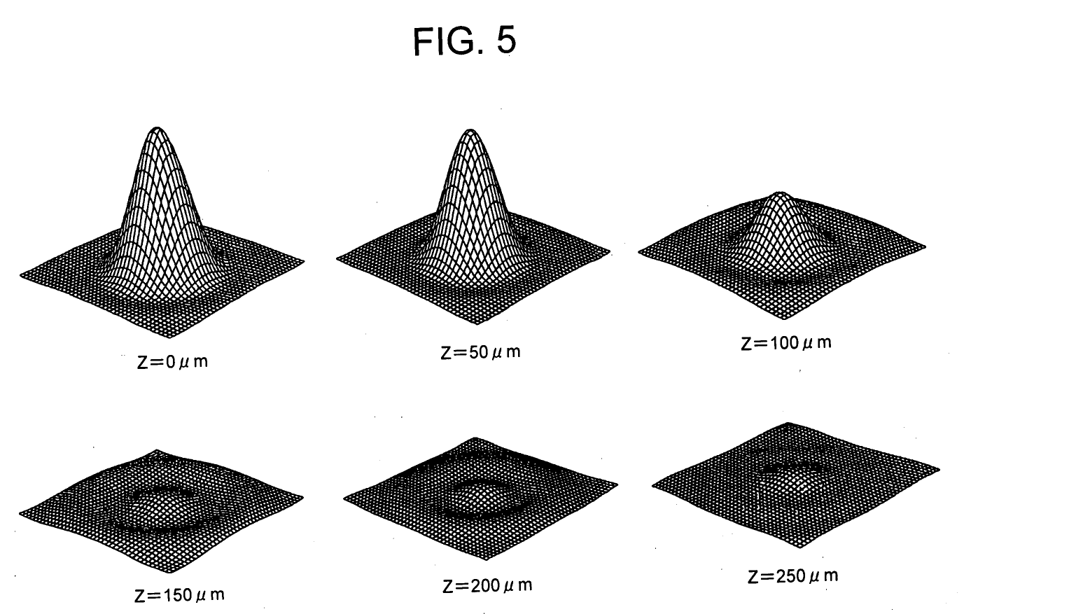

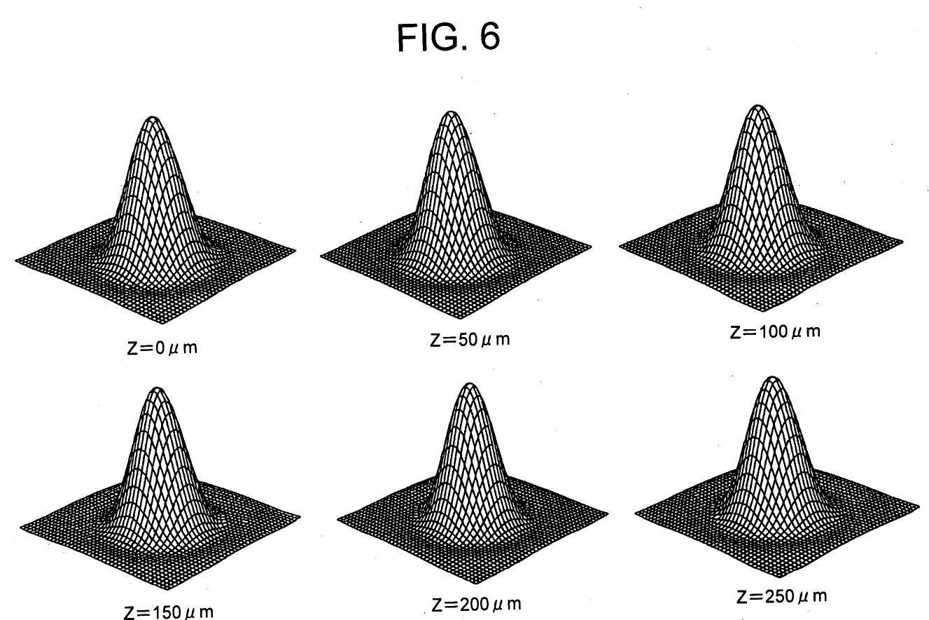

In the following, advantageous effects of the optimum aberration correction taking into account the depth Z will be described with reference to FIGS. 5 and 6.

FIG. 5 shows point spread functions (PFS) (which are simulated data) of the microscope objective lens 11 in the case that no aberration correction depending on the depth Z is performed.

FIG. 6 shows point spread functions (PFS) (which are simulated data) of the microscope objective lens 11 in the case that optimum aberration correction depending on the depth Z is performed.

In FIGS. 5 and 6, point spread functions for depths of 0 μm, 50 μm, 100 μm, 150 μm, 200 μm and 250 μm are shown.

As will be seen from FIG. 5, in the case that no aberration correction depending on the depth Z is performed, there is significant deterioration in the spread function (i.e. flattening of the peak) depending on changes in the depth Z. However, in the case that the optimum aberration correction depending on the depth Z is performed, there is little deterioration in the spread function (i.e. flattening of the peak) depending on changes in the depth Z, as shown in FIG. 6.

As per the above, the optimum aberration correction depending on the depth Z is effective.

(Others)

In this embodiment, when the observation target plane of depth Z1 is to be observed, a target position of the stage 12 with which the focal point of the microscope objective lens 11 coincides with that observation target plane 12 is calculated (in other words, calculation for converting the depth of the observation target plane to the target position of the stage 12 is performed). This calculation is performed based on the set position of the stage 12 after focus adjustment for the observation target plane of depth 0 performed prior to the observation, the set position of the stage 12 for the observation plane of depth Z1 and other factors.

Although not mentioned in the above description, the focal length of the microscope objective lens 11 changes with movement of the aberration correction lens 11B. Therefore, that change in the focal length may be taken into account upon calculation of the target position of the stage 12 carried out by the CPU 23 (see Japanese Patent Application Laid-Open No. 2002-169101).

Furthermore, although in this embodiment, a correspondence table (FIG. 3) is stored in the memory 24 as information representing optimum driving amounts of the aberration correction lens (in this case, optimum rotational positions) for respective observation conditions, information of formula for calculating the optimum rotational positions θ may be stored in place of the correspondence table. In that case, the CPU 23 may determine the optimum rotational position θ using the calculation formula instead of referring to the correspondence table.

Referring to the above-mentioned depth-angle curve θ(Z)_{T,n} (which represents the optimum rotational position θ as a function of the depth Z), it may be considered that the 0th order coefficient defining that curve depends on the temperature T, and the 1st order coefficient depends on the refractive index n. Therefore, relational expression of the 0th order coefficient and the temperature T and relational expression of the n-th order coefficient and the refractive index n may be stored in the memory 24. In that case, a reduction in information amount stored in the memory 24 can be expected.

Although in this embodiment the correction ring 11A is used as a member for moving the aberration correction lens 11B in the optical axis direction, other type of members such as a sliding lever may be used instead.

Although in the microscope system of this embodiment, movement of the stage 12 (i.e. setting of the depth Z of the observation target plane) is performed automatically, it may be performed manually. (In connection with this, the part designated by reference sign 12D in FIG. 1 is a dial that allows the observer to move the stage 12 manually.) In the case that the stage 12 is moved manually, the stage driving mechanism 12M may be omitted. In addition, the process of the CPU 23 for moving the stage 12 is also omitted. Furthermore, entry of the depth Z by the observer is also omitted. In that case, the operation of the microscope system upon observation will be as follows.

The observer moves the stage 12 manually so that the focal point of the microscope objective lens 11 coincides with a desired observation target plane.

The CPU 23 detects the set position of the stage 12 based on a detection signal supplied by the sensor 12S and calculates back the depth Z of the observation target plane based on the set position of the stage 12. (That calculation is performed based on the set position of the stage 12 after focus adjustment with respect to the observation target plane of depth 0 carried out in advance.)

The CPU 23 refers to the correspondence table (shown in FIG. 3A) stored in the memory 24 to determine the depth-angle curve θ(Z)_{T,n} (shown in FIG. 3B) associated with the values of the temperature T and the refractive index n entered by the observer and determines the optimum rotational position for the depth Z based on that depth-angle curve θ(Z)_{T,n}.

The CPU 23 supplies information indicative of that optimum rotational position θ to the lens driving circuit 21 as the target rotational position.

Based on that target rotational position and a detection signal supplied from the sensor 11S, the lens control circuit 21 generates a signal (Δθ) required for rotating the correction ring 11A to the target rotational position and supplies it to the lens driving mechanism 11M. Then, the lens driving mechanism 11M drives the correction ring 11A to rotate it until it assumes the target rotational position. Interlocked with the rotation of the correction ring 11A, the aberration correction lens 11B is moved to the optimum position. (The foregoing is a description of the operation in the case that the stage 12 is moved manually.)

In the description of this embodiment, immersion liquid present between the specimen 10A and the microscope objective lens 11 has not been mentioned. However, when use of immersion liquid is presumed, the refractive index and layer thickness of the immersion liquid should be taken into account upon the above-described experiment or simulation.

In the microscope system of this embodiment, it is presumed that a cover glass is not present between the specimen 10A and the microscope objective lens 11. However, when a specific cover glass is present, the refractive index and thickness of the cover glass should be taken into account upon the above-described experiment or simulation.

In the case that it is assumed in the microscope system of this embodiment that the type of the cover glass is subject to change, the refractive index n′ and/or thickness L′ of the cover glass are additionally included in the parameters for specifying the observation condition.

In that case, information stored in the memory 24 includes information on various observation conditions with different combinations of the temperature T, the refractive index n, the depth Z, the refractive index n′, and the thickness L′ and information indicative of optimum driving amounts of the aberration correction lens 11B associated with those various observation conditions respectively.

Furthermore, in the case that it is assumed in the microscope system of this embodiment that the temperature T of the specimen will not change, the temperature may be excluded from the parameters for specifying the observation condition.

Still further, in the case that it is assumed in the microscope system of this embodiment that the refractive index n of the specimen will not change, the refractive index n may be excluded from the parameters for specifying the observation condition.

In the microscope system of this embodiment, a part or all of the functions of the controller 20 may be allocated to the microscope apparatus 10. In addition, a part or all of the functions of the controller 20 may be executed by a general purpose computer or a dedicated purpose computer.

Furthermore, although in the microscope system of this embodiment the distance between the microscope objective lens 11 and the specimen 10A is changed by moving the stage 12 in the optical axis direction, the microscope objective lens 11 may be moved along the optical axis instead.

Although the microscope apparatus 10 shown in FIG. 1 is an erecting, transmissive, bright-field microscope, the present invention may also be applied to an inverted microscope or other microscopes (such as a cofocal microscope, a microscope using fluorescence microscopy, a microscope using two-photon excited fluorescence microscopy etc.).

In connection with the above, in a general microscope using fluorescence microscopy, the light source wavelength λ of the illumination apparatus is variable. In the case that the wavelength λ is subject to change, the light source wavelength λ may be additionally included in the parameters for specifying the observation condition. In that case, the correspondence table (FIG. 3) should be prepared for each wavelength λ.

[Second Embodiment]

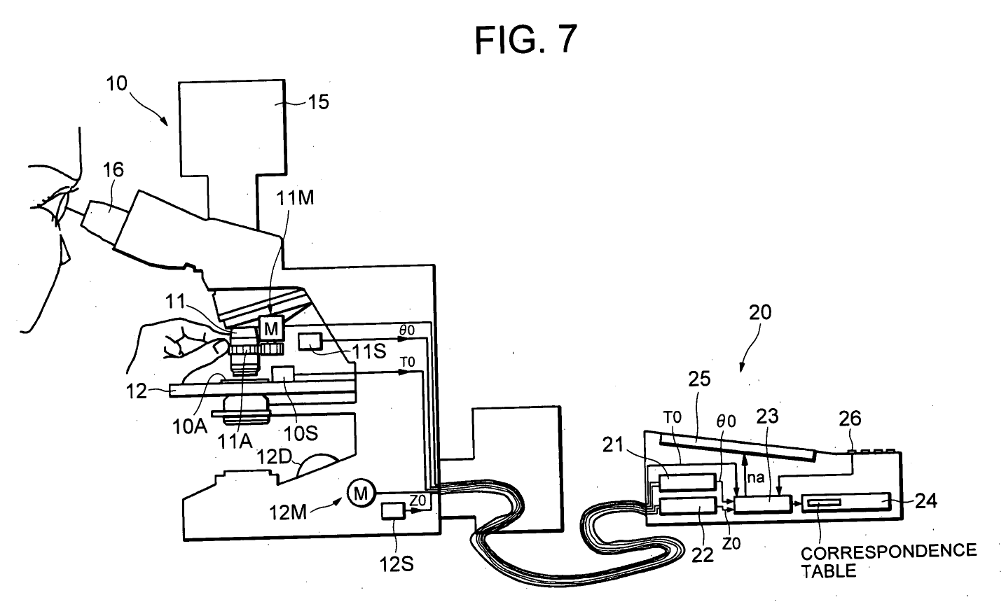

The second embodiment of the present invention will be described with reference to FIG. 7.

This embodiment is directed to a method for measuring the refractive index n of a specimen 10A using a microscope system.

The microscope system used in this embodiment is similar to the microscope system according to the first embodiment but partly modified in such a way as to enable measurement of the refractive index.

As shown in FIG. 7, the microscope apparatus 10 in the microscope system of this embodiment is provided with a sensor 10S disposed in the vicinity of the specimen 10A for measuring the temperature of the specimen 10A.

A detection signal output from the sensor 10S is supplied to a CPU 23 in the controller 20.

The rotational position of a correction ring 11A and set position of a stage 12 along the optical axis direction (i.e. the Z direction) can be changed manually. (In connection with this, reference sign 12D in FIG. 7 designates a dial for allowing the observer to move the stage 12 manually.)

A display device 25 and a switch 26 serve as a user interface for allowing the operator to enter signals necessary for measurement.

In the following, the operation of this microscope system upon measurement will be described.

A specimen 10A as an object to be measured is placed on the stage 12.

The CPU 23 refers to a detection signal output from the sensor 10S to detect the temperature T0 of the specimen 10A.

The operator manually adjusts the rotational position of the correction ring 11A of the microscope objective lens 11 and the position in the Z direction of the stage 12 while observing an image of the specimen through an eyepiece lens or other equipments.

The operator stops the adjustment at the time when the image is clearly observed and supplies the microscope system with a signal by operating the switch 26.

Upon receiving that signal, the CPU 23 detects the set position of the stage 12 and the rotational position θ0 of the correction ring 11A based on detection signals supplied from the sensors 11S and 12S at that time.

Then, the CPU 23 calculates back the depth Z0 of the observation target plane based on the set position of the stage 12. (This calculation is performed based on the set position of the stage 12 after focus adjustment for the observation target plane of depth 0 carried out in advance.)

The CPU 23 determines the refractive index n of the specimen 10A based on the temperature T0, the rotational position θ0 and the depth Z0 obtained by the above-described process using the correspondence table (shown in FIG. 3).

Specifically, the CPU 23 refers to the depth-angle curves θ(Z)_{T0,n1}, θ(Z)_{T0,n2} . . . associated with the temperature T0 picked up from among the multiple depth-angle curves θ(Z)_{T1,n1}, θ(Z)_{T1,n2} . . . stored in the correspondence table.

The CPU 23 determines such one of those depth-angle curves θ(Z)_{T0,n1}, θ(Z)_{T0,n2} . . . that passes through point (Z0, θ0).

Then, the CPU 23 detects the refractive index na associated with the determined depth-angle curve θ(Z)_{Ta,na} and causes the display device 25 to display the value indicating that refractive index na as the refractive index n0 of the specimen 10A.

Thus, the operator can know the refractive index n0 of the specimen 10A from the displayed value.

As per the above, according to the measurement method of this embodiment, the refractive index n0 of the specimen 10A is measured using information stored in the microscope system (i.e. the correspondence table stored in the memory 24) and the hardware of the microscope system.

(Others)

In the case that measurement is performed exclusively with the measurement method of this embodiment, the lens driving mechanism 11M, the stage driving mechanism 12M etc. of the above-described microscope system may be omitted.

The measurement method of this embodiment may be carried out using a microscope system that is not equipped with the sensor 10S.

When the microscope that is not equipped with the sensor 10S is used, the operator sets two combinations of the position of the stage 12 and the rotational position θ0 of the correction ring 11A with which an image of the specimen 10A can be clearly observed so that two sets of information of the depth Z0 and the rotational position θ0 are obtained.

The refractive index n of the specimen 10A can be determined based on these two sets of depth Z0 and rotational position θ0 and the correspondence table. In this connection, the temperature T0 can be also obtained together with the refractive index n.

In the microscope system used in this embodiment, a part or all of the functions of the controller 20 may be allocated to the microscope apparatus 10. In addition, a part or all of the functions of the controller 20 may be executed by a general purpose computer or a dedicated purpose computer.

Furthermore, although in the measurement method of this embodiment the distance between the microscope objective lens 11 and the specimen 10A is changed by moving the stage 12 in the optical axis direction, the microscope objective lens 11 may be moved along the optical axis instead.

Although the microscope apparatus 10 shown in FIG. 7 is an erecting, transmissive microscope, the measurement method may also be carried out using an inverted microscope or other microscopes (such as a cofocal microscope, a fluorescence microscope etc.).

1. A microscope control apparatus for a microscope apparatus attached with a microscope objective lens having an aberration correction lens, comprising:
a memory means in which information on driving amounts of said aberration correction lens that are optimum for various observation conditions respectively;
entry means for allowing an observer to enter a single parameter or multiple parameters for specifying an observation condition set upon observation; and
calculation means for determining a driving amount of said aberration correction lens that is optimum for the observation condition specified by said parameter(s) based on said information.

2. A microscope control apparatus according to claim 1, wherein said parameter(s) includes at least one of the following parameters:
a parameter indicative of a refractive index of an object to be observed;
a parameter indicative of a temperature of said object to be observed;
a parameter indicative of a position of an observation target plane in said object to be observed;
a parameter indicative of a refractive index of a medium present between said observation target plane and said microscope objective lens; and
a parameter indicative of a thickness of the medium present between said observation target plane and said microscope objective lens.

3. A microscope apparatus comprising:
a microscope objective lens having an aberration correction lens;
a memory means in which information on driving amounts of said aberration correction lens that are optimum for various observation conditions respectively;
entry means for allowing an observer to enter a single parameter or multiple parameters for specifying an observation condition set upon observation;
calculation means for determining a driving amount of said aberration correction lens that is optimum for the observation condition specified by said parameter(s) based on said information; and
driving means for driving said aberration correction lens by said determined driving amount.

4. A microscope control apparatus according to claim 3, wherein said microscope objective lens has a correction ring for driving said aberration correction lens along an optical axis direction, and said driving means makes said correction ring rotate.

5. A microscope control apparatus according to claim 4, wherein said microscope apparatus has a sensor for the correction ring which sensor detects rotational position of said correction ring, and said calculation means calculates a drive amount of said drive means for rotating said correction ring in accordance with a detection signal based on information detected by said sensor for the correction ring.

6. A microscope control apparatus according to claim 4, wherein said microscope apparatus has a stage on which a specimen is placed and which is movable along the optical axis of said objective lens, a stage driving means for moving said stage along the optical axis of said objective lens, and a sensor for the stage which detects position of said stage, wherein said stage driving means is driven in accordance with a detection signal based on information detected by said stage sensor.

7. A microscope control apparatus according to claim 4, wherein said microscope apparatus has a lens control portion which controls a drive amount of said driving means for making said correction ring rotate, based on a rotational position of the correction ring detected by said sensor for the correction ring and a target rotational position of said correction ring.

8. A microscope control apparatus according to claim 4, wherein said microscope apparatus has a stage control portion which controls a drive amount of said stage driving means for moving said stage, based on a position of the stage detected by said stage for the sensor and a target rotational position of said stage.

9. A microscope control apparatus according to claim 3, wherein said driving means changes successively observation conditions in accordance with a plurality of parameters entered into said entry means, to drive said aberration correction lens, thereby enabling to perform continuous observation.

10. A microscope control apparatus according to claim 6, wherein said driving means for rotating the correction ring and said stage driving means are respectively motors, wherein said correction ring is manually rotatable, and said stage has a dial for manually moving said stage.
